(19) United States
(12) Patent Application Publication
(10) Pub. No.: US 2026/0302438 A1
(43) Pub. Date: Oct. 1, 2026

(54) CASE FOR SECONDARY BATTERY, SECONDARY BATTERY COMPRISING CASE, AND METHOD FOR MANUFACTURING SECONDARY BATTERY

(71) Applicant: SAMSUNG SDI CO., LTD., Yongin-si (KR)

(72) Inventors: Seo Hyun PARK, Yongin-si (KR); Yoo Jung LEE, Yongin-si (KR)

(21) Appl. No.: 19/282,406

(22) Filed: Jul. 28, 2025

(30) Foreign Application Priority Data
Mar. 28, 2025 (KR) 10-2025-0040036

(51) Int. Cl. H01M 50/105; B60L 50/64; H01M 10/052; H01M 50/121

(52) U.S. Cl. CPC H01M 50/105; H01M 10/052; H01M 50/121; B60L 50/64; H01M 2220/20

(57) ABSTRACT

The present disclosure provides a battery case for a secondary battery comprising an electrode assembly disposed therein, the battery case including a first body having at least one recess configured to accommodate the electrode assembly, and a second body bonded to the first body forming a cover of the battery case, wherein the first body comprises a first cover layer and the second body comprises a second cover layer, wherein the first cover layer faces the second body and the second cover layer faces the first body, wherein a wing part of the first cover layer and a wing part of the second cover layer are bonded to each other, and wherein a portion of the wing part of the first cover layer and a portion of the wing part of the second cover layer form a photonic sintering area.

### CROSS-REFERENCE TO RELATED APPLICATION

The present application claims priority to and the benefit of Korean Patent Application No. 10-2025-0040036, filed on Mar. 28, 2025, in the Korean Intellectual Property Office, the entire disclosure of which is incorporated herein by reference.

### BACKGROUND

### 1. Field

Embodiments of the present disclosure relate to a case for a secondary battery, a secondary battery including the case, and a method for manufacturing the secondary battery.

### 2. Description of Related Art

While primary batteries are not designed to be (re) charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

This Background section is for the general understanding of the background of the present disclosure, and therefore, it may contain information that does not constitute related (or prior) art.

### SUMMARY

Embodiments of the present disclosure provide a case for a pouch-type secondary battery having relatively high stability via an increase in sealing length and an improvement in reliability of an effective sealing part, a secondary battery including the case, and a method for manufacturing the secondary battery.

Embodiments of the present disclosure provide a battery case, in which an electrode assembly is disposed, including: a first body having at least one recess configured to accommodate the electrode assembly; and a second body bonded to the first body to constitute a cover of the battery case, wherein each of the first body and the second body is provided as a plurality of sheet layers, and the first body and the second body include a first cover layer facing the second body within the battery case among the plurality of sheet layers of the first body and a second cover layer facing the first body within the battery case among the plurality of sheet layers of the second body, respectively, and a wing part of the first cover layer and a wing part of the second cover layer are bonded to each other, and at least a portion of the wing parts includes an photonic sintering area on a surface thereof.

Embodiments of the present disclosure provide a battery case for a secondary battery comprising, in which an electrode assembly is disposed therein, the battery case including a first body having at least one recess configured to accommodate the electrode assembly, and a second body bonded to the first body forming a cover of the battery case, wherein the first body comprises a first cover layer and the second body comprises a second cover layer, wherein the first cover layer faces the second body and the second cover layer faces the first body, wherein a wing part of the first cover layer and a wing part of the second cover layer are bonded to each other, and wherein a portion of the wing part of the first cover layer and a portion of the wing part of the second cover layer form a photonic sintering area.

According to some embodiments, a thickness of a portion at which the wing parts of the first and second cover layers are bonded to each other may be substantially uniform in a longitudinal direction.

In some embodiments, a thickness of a the portion at which of the wing parts of the first cover layer and the portion of the wing part the wing part of the second cover layers are bonded to each other, is substantially uniform in a longitudinal direction.

According to some embodiments, an overall thickness of the battery case may be substantially uniform in a longitudinal direction.

According to some embodiments, an entire surface of the wing part of the first cover layer may be bonded to an entire surface of the wing part of the second cover layer.

According to some embodiments, each of both the first cover layer and the second cover layer may be provided as a cast polypropylene (CPP) layer.

In some embodiments, each of the first cover layer and the second cover layer comprises a CPP layer.

According to some embodiments, at least a portion of a side surface of the wing part of the first cover layer, which is exposed to the outside, may include the photonic sintering area.

In some embodiments, the photonic sintering area comprises at least a portion of an exposed side surface of the wing part of the first cover layer, which is exposed to the outside, comprises the photonic sintering area.

According to some embodiments, at least a portion of a side surface of the wing part of the second cover layer, which is exposed to the outside, may include the photonic sintering area.

In some embodiments, the photonic sintering area comprises a portion of an exposed side surface of the wing part of the second cover layer.

Embodiments of the present disclosure provide a secondary battery including: an electrode assembly including a first electrode, a second electrode, and a separator interposed between the first electrode and the second electrode; and a battery case disposed within the electrode assembly, wherein the battery case includes: a first body having at least one recess configured to accommodate the electrode assembly; and a second body bonded to the first body to constitute a cover of the battery case, wherein each of the first body and the second body is provided as a plurality of sheet layers, and the first body and the second body include a first cover layer facing the second body within the battery case among the plurality of sheet layers of the first body and a second cover layer facing the first body within the battery case among the plurality of sheet layers of the second body, respectively, and a wing part of the first cover layer and a wing part of the second cover layer are bonded to each other, and at least a portion of the wing parts includes an photonic sintering area on a surface thereof.

Embodiments of the present disclosure provide a secondary battery comprising: an electrode assembly comprising a first electrode, a second electrode, and a separator, the separator disposed between the first electrode and the second electrode; and a battery case accommodating the electrode assembly, wherein the battery case comprises: a first body having at least one recess accommodating the electrode assembly; and a second body bonded to the first body forming a cover of the battery case, wherein the first body comprises a first cover layer and the second body comprises a second cover layer, wherein the first cover layer faces the second body and the second cover layer faces the first body, wherein a wing part of the first cover layer and a wing part of the second cover layer are bonded to each other, and wherein a portion of the wing part of the first cover layer and a portion of the wing part of the second cover layer form a photonic sintering area.

According to some embodiments, at least a portion of a side surface of the wing part of the first cover layer, which is exposed to the outside, may include the photonic sintering area.

In some embodiments, the photonic sintering area comprises a portion of an exposed side surface of the wing part of the first cover layer.

According to some embodiments, at least a portion of a side surface of the wing part of the second cover layer, which is exposed to the outside, may include the photonic sintering area.

In some embodiments, the photonic sintering area comprises a portion of an exposed side surface of the wing part of the second cover layer.

According to some embodiments, an entire surface of the wing part of the first cover layer may be bonded to an entire surface of the wing part of the second cover layer.

According to some embodiments, each of both the first cover layer and the second cover layer may be provided as a CPP layer.

In some embodiments, each of the first cover layer and the second cover layer comprises a CPP layer.

Embodiments of the present disclosure provide a method for manufacturing a secondary battery including: preparing a first body having at least one recess that accommodates an electrode assembly and a second body that shares at least one edge with the first body; disposing a first cover layer facing the second body within a battery case among a plurality of sheet layers of the first body and a second cover layer facing the first body within the battery case among a plurality of sheet layers of the second body so that the first cover layer and the second cover layer are in contact with each other, wherein each of the first body and the second body is provided as the plurality of sheet layers; and performing photonic sintering on the first and second bodies after the first and second cover layers are in contact with each other so that a wing part of the first cover layer and a wing part of the second cover layer are bonded to each other.

Embodiments of the present disclosure provide a method for manufacturing a secondary battery, the method comprising: preparing a first body having at least one recess accommodating an electrode assembly and providing a second body sharing at least one edge with the first body; disposing a first cover layer to face the second body and disposing a second cover layer to face the first body so that the first cover layer and the second cover layer are in contact with each other; and performing photonic sintering on the first body and the second body so that a wing part of the first cover layer and a wing part of the second cover layer are bonded to each other.

According to some embodiments, in the performing of the photonic sintering, the performing of the photonic sintering may include irradiating light from each of side surfaces of the first and second bodies.

In some embodiments, the performing comprises irradiating light from each side surface of the first body and the second body.

According to some embodiments, the performing of the photonic sintering may include irradiating pulsed light.

In some embodiments, the performing comprises irradiating pulsed light.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings:

FIG. 1 illustrates a schematic exploded perspective view of a secondary battery according to embodiments of the present disclosure;

FIG. 2 illustrates a partial exploded perspective view of an electrode assembly disposed in the secondary battery of FIG. 1;

FIG. 3 illustrates a schematic cross-sectional view taken along line A-A′ in the battery case of FIG. 1;

FIG. 4 illustrates a schematic top surface of the battery case of FIG. 1 when viewed from the top;

FIGS. 5A and 5B illustrate a cross-sectional view of the battery case before a first body and a second body are coupled to each other, i.e., before applying a sealing process, and a cross-sectional view of the battery case sealed after the first body and the second body are coupled to each other, i.e., after applying the sealing process, respectively, according to prior art;

FIG. 6 illustrates a flowchart of a method for manufacturing a secondary battery according to embodiments of the present disclosure;

FIG. 7 illustrates a schematic view of a photonic sintering process shown in the flowchart of FIG. 6;

FIGS. 8A and 8B illustrate perspective views of a battery pack including a secondary battery according to embodiments of the present disclosure; and

FIGS. 9A and 9B illustrate perspective and side views, respectively, of a vehicle including a battery pack according to embodiments of the present disclosure.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

The present disclosure provides an example in which a secondary battery is described as a pouch-type secondary battery, but this is only for convenience of description. The present disclosure is not limited thereto, and the same technical idea is applied to a cylindrical secondary battery, or a square secondary battery, etc.

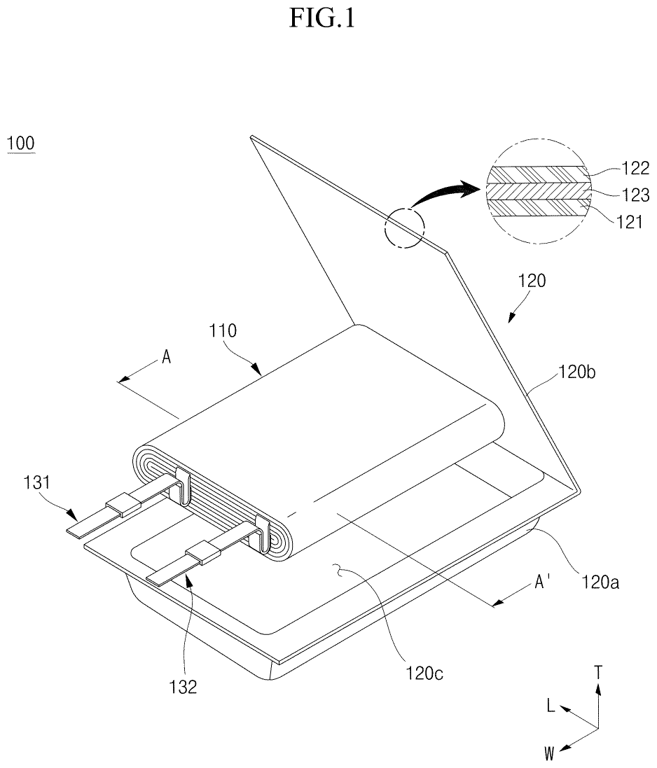

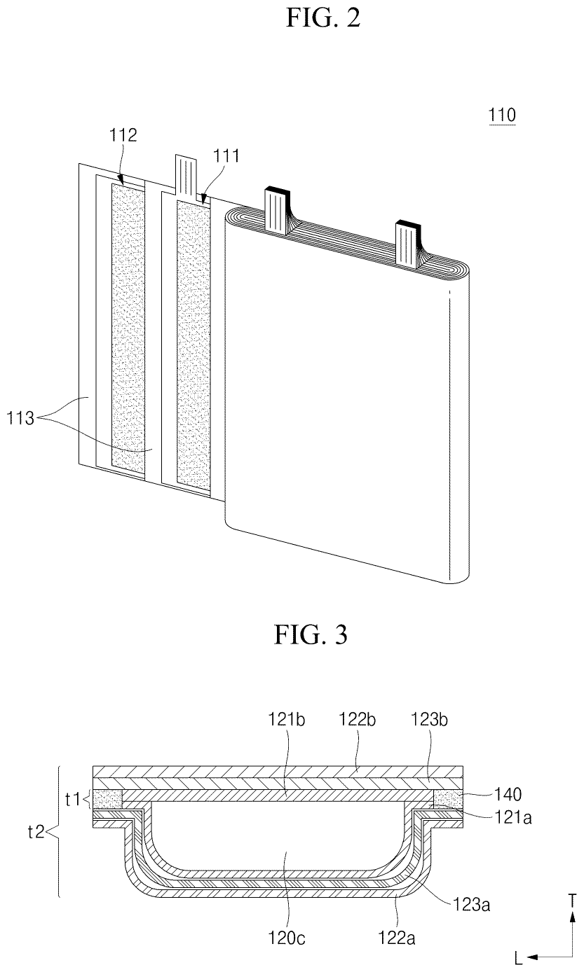

FIG. 1 illustrates a schematic exploded perspective view of a secondary battery 100 and FIG. 2 illustrates a partial exploded perspective view of an electrode assembly 110 disposed in the secondary battery 100 of FIG. 1. As illustrated in FIG. 1 and FIG. 2, the secondary battery 100 may generally include an electrode assembly 110 and a battery case 120 containing the electrode assembly 110 therein.

The electrode assembly 110 may be provided by winding or stacking a stack of a first electrode plate 111, a second electrode plate 112, and a separator 113 disposed between the first electrode plate 111 and the second electrode plate 112, each of which may have a thin plate or film geometry. If the electrode assembly 110 is a wound stack, a winding axis may be parallel to a direction of a width W of the case 120. The electrode assembly 110 may be provided in a stack type rather than the winding type. The electrode assembly 110 may be a Z-stack electrode assembly in which a first electrode plate and a second electrode plate are inserted on both sides of a separator 113 that is folded in the form of a Z-stack. The electrode assembly 110 may be accommodated inside the case 120 by stacking one or more electrode assemblies 110 adjacent to each other. In some embodiments, the first electrode plate 111 of the electrode assembly 110 may serve as a negative electrode and the second electrode plate 112 may serve as a positive electrode, and vice versa.

The first electrode plate 111 may be made of metal foil including copper, a copper alloy, nickel, or a nickel alloy. The first electrode plate 111 may include a first electrode active material layer on which a first electrode active material (e.g., a negative electrode active material) such as graphite or carbon is applied to at least one surface. In some embodiments, the first electrode plate may include a plurality of first non-coating portions where the first electrode active material is not applied. In some embodiments, the first non-coating portion may be provided by notching or cutting the first electrode plate 111 in advance to protrude from one side and protrude beyond the separator 113 without separate cutting. In some embodiments, a first electrode lead tab 131 may be bonded to the first non-coating portion. The first electrode lead tab 131, which transmits electrons collected in the first electrode plate to an external circuit and, for example, may be provided as a nickel plate, and may be bonded to the first non-coating portion.

The second electrode plate 112 may include a second electrode active material layer which is provided as metal foil including aluminum or an aluminum alloy and on which a second electrode active material (e.g., a positive electrode active material) such as transition metal oxide is applied to at least one surface thereof. In some embodiments, the second electrode plate may include a plurality of second non-coating portions where the second electrode active material is not applied. In some embodiments, the second non-coating portion may be provided by notching or cutting the second electrode plate 112 in advance to protrude from one side and protrude beyond the separator 113 without separate cutting.

The first non-coating portion of the first electrode plate 111 and the second non-coating portion of the second electrode plate 112 may be spaced apart from each other on one end of the electrode assembly 110.

In some embodiments, a second electrode lead tab 132 may be bonded to the second non-coating portion 1123. A second electrode lead tab 132, which transmits electrons collected in the second electrode plate to an external circuit and, for example, may be provided as a nickel plate, and may be bonded to the second non-coating portion.

The first electrode lead tab 131 and the second electrode lead tab 132 may be bonded to the plurality of first non-coating portions, on which the first electrode active material layer is not applied, and the plurality of second electrode non-coating portions, on which the second electrode active material layer is not applied. In some embodiments, the first electrode lead tab may be bonded to the outermost side of the first non-coating portion, and the second electrode lead tab is bonded to the outermost side of the second non-coating portion, and the positions to which the first and second electrode lead tabs 131 and 132 are attached are not limited to a specific position.

The first and second non-coating portions may correspond to vulnerable portions at which short circuit between the positive electrode and the negative electrode occurs, and an insulating layer coating technology may be applied to protect the vulnerable portions. For example, an insulating tape may cover at least one end of both ends of the active material layer for the negative or positive electrode plates. The shape and material of the insulating tape are not limited, but the insulating tape may include an adhesive layer and an insulating film attached to one side of the adhesive layer to cover at least one end of the active material layer having a width substantially equal to a width of the active material layer. For example, the adhesive layer may include an ethylene-acrylic ester copolymer, a rubber-based adhesive, or an ethylene vinyl acetate copolymer, and the insulating film may include polypropylene, polyethylene terephthalate, or polyethylene naphthalate.

The electrode assembly 110 may be accommodated in a battery case 120 together with the electrolyte. The plurality of first non-coating portions of the first electrode plate and the plurality of second non-coating portions of the second electrode plate may be welded and connected to the first electrode lead tab 131 and the second electrode lead tab 132, respectively, and be disposed within the battery case.

The first electrode lead tab 131 and the second electrode lead tab 132 may extend from the interior to the exterior of the case 120. The first electrode lead tab 131 and the second electrode lead tab 132 may be spaced apart from each other, similar to the first non-coating portion and the second non-coating portion being spaced apart from each other. For example, the first electrode lead tab 131 may include metal foil including copper, a copper alloy, nickel, or a nickel alloy, and the second electrode lead tab 132 may include metal foil including aluminum or an aluminum alloy.

The electrolyte may include a non-aqueous organic solvent, lithium salt, and/or insulating particles.

The non-aqueous organic solvent acts as a medium through which ions involved in the electrochemical reaction of the battery can migrate.

The non-aqueous organic solvent may include a carbonate-based, an ester-based, an ether-based, a ketone-based, an alcohol-based solvent, an aprotic solvent, or combinations thereof.

In addition, when a carbonate-based solvent is used, a mixture of cyclic carbonate and chain carbonate may be used.

The lithium salt may include, for example, lithium hexafluorophosphate (LiPF₆), lithium trifluoromethanesulfonate (LiTFSI), lithium bis(fluorosulfonyl)imide (LiFSI), etc.

Referring to FIG. 1, the battery case 120 may accommodate the electrode assembly 110 together with the electrolyte.

The battery case 120 may include or be referred to as a housing, an exterior, a laminate exterior, or a pouch. For example, the battery case 120 may include a first body 120a including at least one recess 120c that accommodates the electrode assembly and a second body 120b that is substantially flat and is bonded to the first body to constitute the cover of the battery case. A wing part, i.e., a sealing area may be provided around the recess 120c of the first body 120a, and the first body and the second body may be bonded to each other through the sealing area to implement an overall shape of the pouch-type secondary battery. Each of the first body 120a and the second body 120b of the case 120 may be provided as a multilayer structure including a first insulating layer 121, a second insulating layer 122, and a metal layer 123 between the first and second insulating layers. In addition to the first and second insulating layers and the metal layer, various adhesive layers or functional layers may be added.

The first insulating layer 121 may define an inner surface of the battery case and may include a material having insulating and thermal adhesive properties. In some embodiments, the first insulating layer 121 may be provided on one surface of the metal layer 123 to define an inner surface facing the electrode assembly. For example, the first insulating layer 121 may include polypropylene (PP) or cast polypropylene (CPP), a material that does not react with the electrolyte. The case 120 may be sealed as a whole while the first insulating layer of the first body and the first insulating layer of the second body are bonded to each other through a process of accommodating the electrode assembly in the recess 120c of the first body 120a to bond the second body 120b to the first body 120a. In some embodiments, the first insulating layer of the first body may include at least a first cover layer 121a, and the first insulating layer of the second body may include at least a second cover layer 121b. The first cover layer 121a may provide the seal while facing the second cover layer 121b.

The metal layer 123 may be a layer interposed between the first insulating layer 121 and the second insulating layer 122 and prevent moisture and/or oxygen from being introduced from the exterior. If the electrolyte is filled within the case 120, the metal layer 123 may prevent the electrolyte from leaking. In some embodiments, the metal layer 123 may maintain mechanical strength of the case 120. In some embodiments, the metal layer 123 may include aluminum, an aluminum alloy, iron, or an iron alloy. In some embodiments, the metal layer of the first body may include at least a first metal layer 123a, and the metal layer of the second body may include at least a second metal layer 123b.

The second insulating layer 122 may be provided as an outer surface of the case 120 to mitigate mechanical and chemical impacts from external electronic devices. In some embodiments, the second insulating layer 122 may be provided on the other surface of the metal layer 123 and may define an outer surface of the case 120. The second insulating layer 122 may include nylon, polyethylene terephthalate (PET), polybutylene terephthalate (PBT), or polybutylene naphthalate (PBN). In some embodiments, the second insulating layer of the first body may include at least a second outer layer 122a, and the second insulating layer of the second body may include at least a second outer layer 122b.

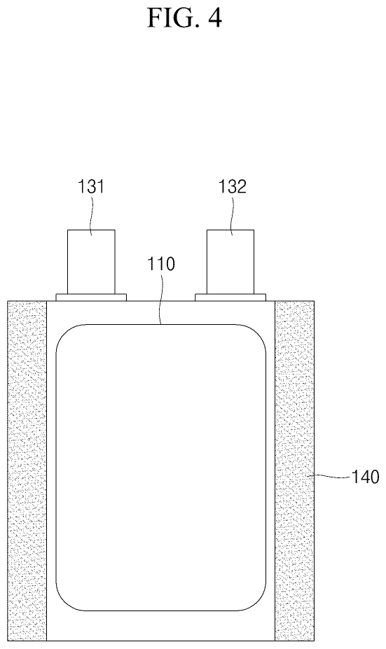

FIG. 3 illustrates a schematic cross-sectional view taken along line A-A′ in the battery case 120 of FIG. 1, and FIG. 4 illustrates a schematic top surface of the battery case 120 of FIG. 1 when viewed from the top.

Referring to FIGS. 3 and 4, the first body 120a having the recess for accommodating the electrode assembly and the electrolyte may include at least the first cover layer 121a, the first metal layer 123a, and the first outer layer 122a. Similarly, the second body 120b covered over the first body 120a may include at least the second cover layer 121b, the second metal layer 123b, and the second outer layer 122b. In some embodiments, the case may be sealed by bonding the wing part of the first cover layer 121a to the wing part of the second cover layer 121b. At least a portion of the wing part of the first cover layer and the wing part of the second cover layer may include a photonic sintering area 140 on a surface facing the other cover layer, and the sealing of the case may be achieved through the bonding between the respective photonic sintering areas.

Referring to FIG. 3, a thickness t1 of the wing part of each of the first cover layer 121a and the second cover layer 121b, bonded to each other, may be substantially uniform with respect to a longitudinal direction L of the battery case. When the first body and the second body are bonded to each other, the sealing area may be uneven due to the curved shape of the pouch. As a result, the effective sealing length is reduced along the longitudinal direction of the battery case, and the bonding part, at which the first cover layer of the first body and the second cover layer of the second body face each other and are bonded to each other, may not have a uniform thickness. For example, the two edges of the bonding part may have different thicknesses. For example, an outer edge of the bonding part may be thicker than that of an inner edge due to a close contact structure of a sealing device. Advantageously, the present disclosure provides that, via the bonding between the photonic sintering areas, the thickness of the bonding part in the longitudinal direction is substantially the same. In some embodiments, an overall thickness t2 may be substantially uniform with respect to the longitudinal direction L of the battery case.

Even after the first cover layer 121a and the second cover layer 121b are bonded to each other, the overall thickness t2 of the battery case may be substantially uniform because the thickness before the bonding of the first cover layer and the second cover layer is maintained as is.

This is because the photonic sintering process is introduced during the process of sealing the pouch-type battery case. Accordingly, uniformity of melting of the wing parts of the first and second cover layers is ensured throughout the entire longitudinal direction, more specifically, throughout the entire bonding area of the wing parts of the first and second cover layers.

The ensuring of the uniformity of the melting of the wing part refers to the effective sealing length for bonding the first body to the second body increasing along the longitudinal direction L and the width direction W. As a result, the bonding reliability between the first and second bodies may be improved. The photonic sintering process may be introduced to improve the uniformity in thickness and area of the effective sealing part. As a result, overall mechanical strength of the battery case may be improved.

In some embodiments, the photonic sintering area 140 applied to the battery case may be provided on at least one side surface of the first cover layer and the second cover layer. A lamp used for forming the photonic sintering area 140 is applied to the sealing part of the battery case from the side surface of the battery case, that is, the side surfaces of the first cover layer and the second cover layer.

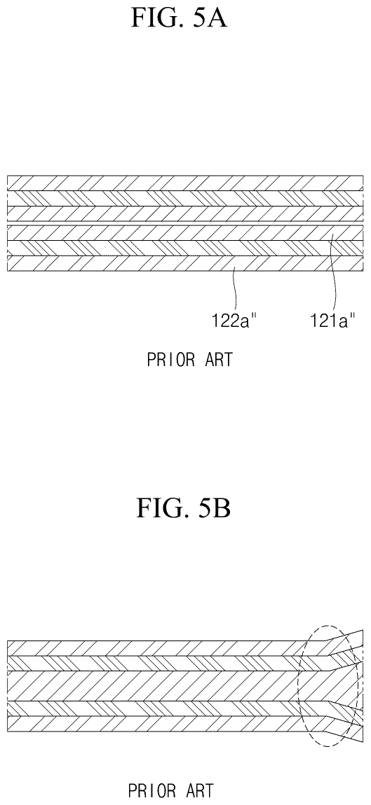

A battery case according to prior art, which does not include the photonic sintering area in the wing parts of the first and second cover layers, is described with reference to FIGS. 5A and 5B. FIGS. 5A and 5B illustrate a cross-sectional view of the battery case before the first body and the second body are coupled to each other, i.e., before applying a sealing process, and a cross-sectional view of the battery case sealed after the first body and the second body are coupled to each other, i.e., after applying the sealing process, respectively.

Referring to FIG. 5A, the first body may have a structure in which the first cover layer, the first metal layer, and the first outer layer are laminated as a layered structure of a plurality of films, and the second body may have a structure in which the second cover layer, the second metal layer, and the second outer layer are laminated as a layered structure of a plurality of films. Although not limited thereto, as an example, the cover layer, the metal layer, and the outer layer may have thicknesses of about 30 μm, about 20 μm, and about 40 μm, respectively, and the overall thickness may be about 180 μm.

Referring to FIG. 5B, if the first body and the second body are bonded to each other, the uneven sealing area may be provided due to the sealing device and the curved shape of the pouch, and the effective sealing length may be reduced along the width direction or longitudinal direction of the battery case. For example, in a left hand side area of FIG. 5B, the overall thickness of the plurality of films of the first body and the second body after the bonding may be about 160 μm, whereas in a right hand side area, the overall thickness may be about 180 μm, resulting in thickness discrepancy, having a non-uniform length of the effective sealing part. In some embodiments, the overall sealing reliability may not be uniform, and the bonding between the first and second bodies may not be reliable in some wing parts.

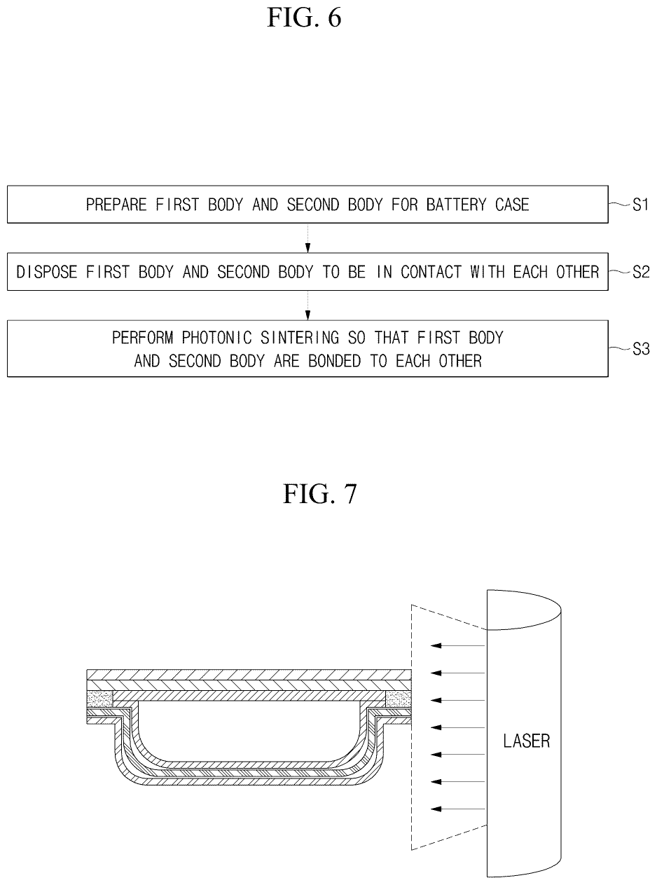

FIG. 6 illustrates a flowchart of a method for manufacturing a secondary battery. Referring to FIG. 6, a process of sealing a battery case may include following processes.

A process (S1) is performed preparing a first body having at least one recess that accommodate an electrode assembly and a second body that shares at least one edge with the first body. Although the second body may not include a separate recessed space, or the second body may include a curved part such as the first body, if necessary.

Each of the first body and the second body may be provided as a plurality of sheet layers, and a process (S2) is performed in which a first cover layer of the plurality of sheet layers of the first body, which faces the second body within the battery case, and a second cover layer of the plurality of sheet layers of the second body, which faces the first body within the battery case, are disposed to be in contact with each other.

A photonic sintering process (S3) is performed in which the first and second cover layers are in contact with each other. Photonic sintering is performed on the first and second bodies so that a wing part of the first cover layer and a wing part of the second cover layer are bonded to each other. Because a separate process such as applying a sealant (sealer) is omitted, thickness discrepancy on a sealing area may be prevented and an effective sealing length, depending on the uniformity of application of the sealer, may be ensured.

FIG. 7 schematically illustrates the photonic sintering process (S3) in FIG. 6, showing a process of applying pulsed light from each side surface of the first and second bodies. A laser light source may be used to irradiate a pulsed light onto the surface to promote reduction and oxidation reactions of surface materials, thereby controlling mechanical performance of the material. For example, if a high-temperature high-pressure pulse electric field is applied using a xenon lamp, energy of the light source may cause existing bonding on the surface to break, resulting in new crystal growth and/or assembly. As a result, the material may undergo changes in its original physicochemical properties and acquire high-strength characteristics due to particle assembly and reduction at the grain boundary.

In some embodiments, as an example, in the photonic sintering process, the pulsed light may be applied for about 10 ms to about 100 ms at a temperature of about 20° C. to about 60° C. After applying the pulsed light under such conditions, it may be subsequently cooled to room temperature. The photonic sintering process of the present disclosure is not limited to the such conditions, and a person skilled in the art may appropriately set the process conditions according to the required characteristics or manufacturing environment. Such conditions may be easily met by applying the high intensity pulsed light. As a result, only the first cover layer and the second cover layer, for example, the CPP layers, among the plurality of film layers of the first body and the second body, may be selectively melted to uniformly form the effective sealing part, resulting in an effective sealing part.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like. A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

Although the present disclosure is described based on the pouch-type secondary battery 100, it should be emphasized that the electrode assembly 110 is provided in a similar or identical configuration or manner to a square secondary battery or a cylindrical secondary battery.

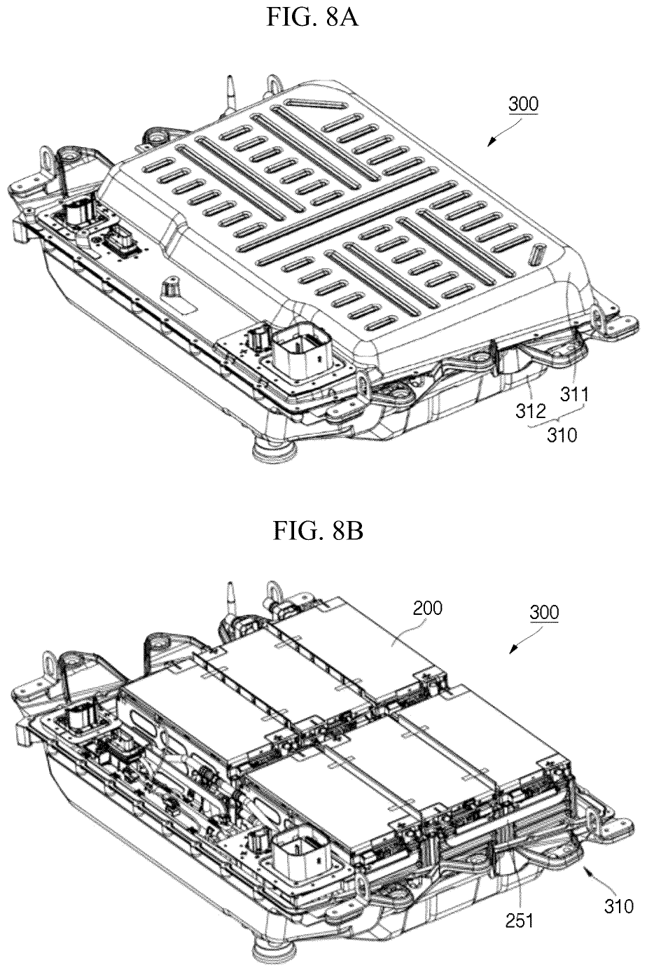

FIGS. 8A and 8B are perspective views showing a battery pack 300 including the secondary battery. Referring to FIGS. 8A and 8B, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 8A and 8B, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

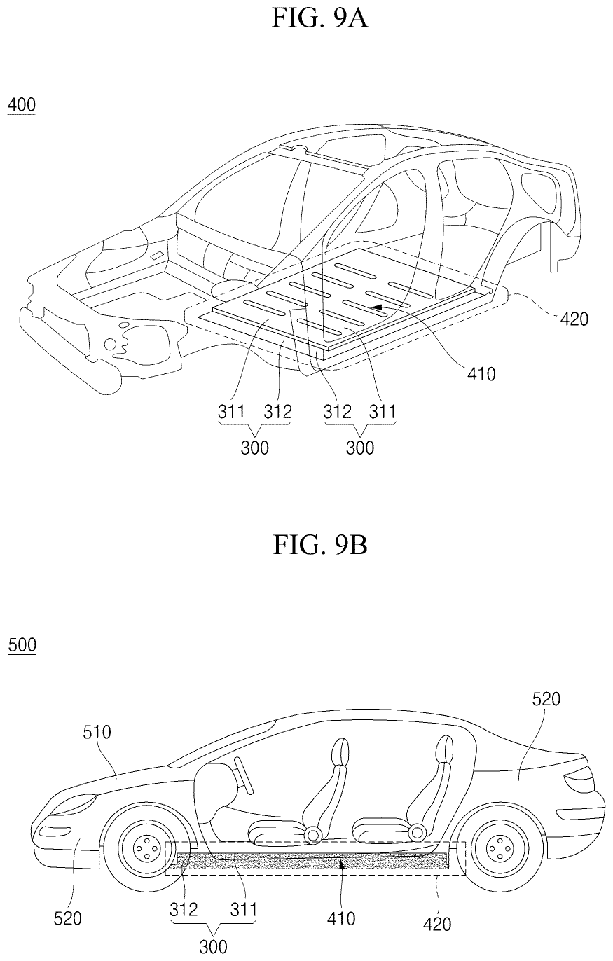

FIGS. 9A and 9B are perspective and side views, respectively, showing vehicles 400 and 500 including the battery pack 300. In FIG. 9A, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 9B, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

According to the embodiments of the present disclosure, the melting uniformity of the insulating layer within the case may be ensured through the surface modification of the insulating layer, which provides the case of the pouch-type secondary battery, to provide the highly stable secondary battery case and the secondary battery including the same.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A battery case for a secondary battery comprising an electrode assembly disposed therein, the battery case comprising:
a first body having at least one recess configured to accommodate the electrode assembly; and
a second body bonded to the first body forming a cover of the battery case,
wherein the first body comprises a first cover layer and the second body comprises a second cover layer,
wherein the first cover layer faces the second body and the second cover layer faces the first body,
wherein a wing part of the first cover layer and a wing part of the second cover layer are bonded to each other, and
wherein a portion of the wing part of the first cover layer and a portion of the wing part of the second cover layer form a photonic sintering area.

2. The battery case as claimed in claim 1, wherein a thickness of the portion of the wing part of the first cover layer and the portion of the wing part the wing part of the second cover layer, bonded to each other, is substantially uniform in a longitudinal direction.

3. The battery case as claimed in claim 1, wherein an overall thickness of the battery case is substantially uniform in a longitudinal direction.

4. The battery case as claimed in claim 1, wherein an entire surface of the wing part of the first cover layer is bonded to an entire surface of the wing part of the second cover layer.

5. The battery case as claimed in claim 1, wherein each of the first cover layer and the second cover layer comprises a cast polypropylene layer.

6. The battery case as claimed in claim 1, wherein the photonic sintering area comprises a portion of an exposed side surface of the wing part of the first cover layer.

7. The battery case as claimed in claim 1, wherein the photonic sintering area comprises a portion of an exposed side surface of the wing part of the second cover layer.

8. A secondary battery comprising;
an electrode assembly comprising a first electrode, a second electrode, and a separator, the separator disposed between the first electrode and the second electrode; and
a battery case accommodating the electrode assembly,
wherein the battery case comprises:
a first body having at least one recess accommodating the electrode assembly; and
a second body bonded to the first body forming a cover of the battery case,
wherein the first body comprises a first cover layer and the second body comprises a second cover layer,
wherein the first cover layer faces the second body and the second cover layer faces the first body,
wherein a wing part of the first cover layer and a wing part of the second cover layer are bonded to each other, and
wherein a portion of the wing part of the first cover layer and a portion of the wing part of the second cover layer form a photonic sintering area.

9. The secondary battery as claimed in claim 8, wherein the photonic sintering area comprises a portion of an exposed side surface of the wing part of the first cover layer.

10. The secondary battery as claimed in claim 8, wherein the photonic sintering area comprises a portion of an exposed side surface of the wing part of the second cover layer.

11. The secondary battery as claimed in claim 8, wherein an entire surface of the wing part of the first cover layer is bonded to an entire surface of the wing part of the second cover layer.

12. The secondary battery as claimed in claim 8, wherein each of the first cover layer and the second cover layer comprises a cast polypropylene layer.

13. A method for manufacturing a secondary battery, the method comprising:
preparing a first body having at least one recess accommodating an electrode assembly and providing a second body sharing at least one edge with the first body;
disposing a first cover layer to face the second body and disposing a second cover layer to face the first body so that the first cover layer and the second cover layer are in contact with each other; and
performing photonic sintering on the first body and the second body so that a wing part of the first cover layer and a wing part of the second cover layer are bonded to each other.

14. The method as claimed in claim 13, wherein the performing comprises irradiating light from each side surface of the first body and the second body.

15. The method as claimed in claim 13, wherein the performing comprises irradiating pulsed light.
